(19) United States
(12) Patent Application Publication
(10) Pub. No.: US 2017/0358023 A1
(43) Pub. Date: Dec. 14, 2017

(54) SYSTEM AND METHOD FOR IDENTIFYING AND USING OBJECTS IN VIDEO

(71) Applicant: DIBZIT.COM, INC., Missoula, MT (US)

(72) Inventor: Scott PETERSON, Missoula, MT (US)

(21) Appl. No.: 15/524,216

(22) PCT Filed: Nov. 3, 2015
(86) PCT No.: PCT/US15/58733

§ 371 Date: May 3, 2017

Related U.S. Application Data
(60) Provisional application No. 62/074,341, filed on Nov. 3, 2014.

(51) Int. Cl. G06Q 30/06; G06F 3/0484

(52) U.S. Cl. CPC G06Q 30/0643; G06F 3/04842; G06Q 30/0633

(57) ABSTRACT

An improved system and method for interacting and/or purchasing objects of interest within a video is provided. A product ephemeris generation process is configured to create a product ephemeris comprised of object trajectories, or time-ordered sets of x, y, and/or z coordinates that describe the path or paths of the objects of interest contained in a product index. The location of the objects within the video can be established by tracing and/or tagging the objects of interest, either manually and/or with object recognition software. A point of sale system receives input from a view by a pointing device, including a video content identification, a time tag, and/or coordinates sufficient to locate the object on the display. The point of sale system correlates the selected input with products from the product index. The correlated products can be added to an electronic shopping cart and purchased.

### CROSS-REFERENCE TO RELATED APPLICATIONS

This application claims priority to U.S. provisional application Ser. No. 62/074,341, filed Nov. 3, 2014, which is hereby incorporated by reference in its entirety.

### FIELD OF THE DISCLOSURE

The disclosure relates to video systems. In particular, this disclosure relates to identifying objects in videos and enabling users to interact with a video system to perform tasks relating to identified objects.

### BACKGROUND OF THE DISCLOSURE

Whether impromptu video captured by a video camera, or scripted videos such as television or movies, objects within the videos are ubiquitous. For example, in television programs and/or movies, objects can include things associated with the production set on which the videos are filmed. Such objects can include furniture, appliances, artwork, or any other goods or services contained therein. Furthermore, product placement or other advertising in television programs and/or movies has become commonplace over the past few decades.

When watching videos such as television programs and movies, a viewer might find objects in the videos appealing and wish to purchase the same. For example, a viewer might find want to purchase the sofa (or a sofa similar to the one) used on a sitcom. An opportunity to do so is unlikely, however, because the viewer does not know the manufacturer, make, or model of the sofa he or she wishes to purchase. Not only is this disadvantageous for the viewer, but also the manufacturer similarly loses an opportunity to sell one or more units of its product. Therefore, a need exists in the art for viewers to be able to identify objects seen in videos.

Even when a product on a video is more readily identifiable, whether through commonly known trade dress or specifically placed products, the steps required of a viewer to purchase the same can be burdensome. In some instances, the viewer must locate a retailer who sells the product and travel to the store to purchase. Such an arrangement is inconsistent with the advent and explosion of smart televisions and electronic commerce. In other instances where the viewer is attempting to purchase the product online, he or she must first locate an online retailer who sells the product and perform the transaction. Therefore, a further need exists in the art for a system and method by which a viewer watching a video can easily and rapidly identify and/or purchase the products contained therein. These and other deficiencies in the art will be readily apparent from the description and claims disclosed herein.

### SUMMARY OF THE DISCLOSURE

It is therefore a primary object, feature, and/or advantage of the present invention to improve on or overcome the deficiencies in the art.

Another object, feature, and/or advantage of the present disclosure is to identify objects seen in videos. Still another object, feature, and/or advantage of the present disclosure is to conveniently purchase the products contained within videos.

These and/or other objects, features, and advantages of the present disclosure will be apparent to those skilled in the art. The present disclosure is not to be limited to or by these objects, features and advantages. No single embodiment need provide each and every object, feature, or advantage.

According to an aspect of the disclosure, a method for a viewer to interact with objects within a video is provided. The method includes the steps of determining elapsed times and locations of the objects of interest. The location of the objects within the video can include tracing and/or tagging the objects of interest, either manually and/or with object recognition software. Trajectories of the objects are characterized based on their locations as a function of elapsed times through a product ephemeris generation process.

Characterizing the trajectories of the objects can further include recording on-screen x, y, and/or z coordinates of the objects at a plurality of the elapsed times. The trajectories of the objects are correlated with one or more products from a product index. The viewer is allowed to select one of the trajectories with a pointing device. Candidate products correlated to the selected trajectory are identified. The correlated products can be added to an electronic shopping cart and purchased.

According to another aspect of the disclosure, a method for allowing a viewer to interact with an object within a prerecorded video includes providing a pointing device and an electronic shopping cart.

The object within the prerecorded video is characterized as a trajectory. The trajectory represents the location as a function of elapsed time of the video. The trajectory of the object is correlated with a product. The viewer is allowed to select a location within the prerecorded video with the pointing device. The location is associated with the object of interest and/or product. The product can be associated with the electronic shopping cart and/or purchased by the viewer.

The object within the prerecorded video can be characterized by iteratively tracing the outline of the object. The tracing may not be visible to the viewer during viewing of the video. The tracing of the object can be represented as coordinates as the function of the elapsed time of the video.

According to still another aspect of the present disclosure, a system of identifying or purchasing an object in video content is provided. The system includes a display through which video content is displayed. A product ephemeris generation process is configured to create a product ephemeris comprised of a time-ordered set of x, y, and/or z coordinates that describe the path or paths of the object contained in a product index. A point of sale system is configured to receive input from a system device upon activation by a user. The input includes a video content identification, a time tag, and coordinates sufficient to locate the object on the display. The point of sale system correlates the received input with one or more candidate products from the product ephemeris.

The system can further include an electronic shopping cart. The point of sale system can deposit the one or more candidate products into the electronic shopping cart. The user can purchase the candidate products with the point of sale system.

Other objects, advantages and features of the present invention will become apparent from the following specification taken in conjunction with the accompanying drawings.

### BRIEF DESCRIPTION OF THE DRAWINGS

Illustrated embodiments of the disclosure are described in detail below with reference to the attached drawing figures, which are incorporated by reference herein, and where:

FIG. 1 is a rendering of an exemplary frame of a video in accordance with an illustrate embodiment of the present disclosure;

FIG. 2 is a production set in accordance with an illustrate embodiment of the present disclosure; and

FIG. 3 is schematic diagram of a system in accordance with an illustrative embodiment of the present disclosure.

Various embodiments of the present invention will be described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention.

### DETAILED DESCRIPTION

The following disclosure describes, among other things, methods and systems for capturing, characterizing, and/or collating information regarding the location and movement of objects, sound, and/or music in videos for subsequent use by viewers to identify the objects, and interact with and/or perform operations on them. Examples include typifying the appearance, disappearance and motion (i.e., trajectories) of products across the scenes of videos, and then providing a viewer the ability to use a pointing device to select one or more of the objects within the video. The selected objects can be deposited into an online shopping cart. Further, background information on the object in question can be retrieved, including educational information. At least two methods of identifying object motion are envisioned: post-production capture and live capture, but the present disclosure contemplates that other methods are also possible.

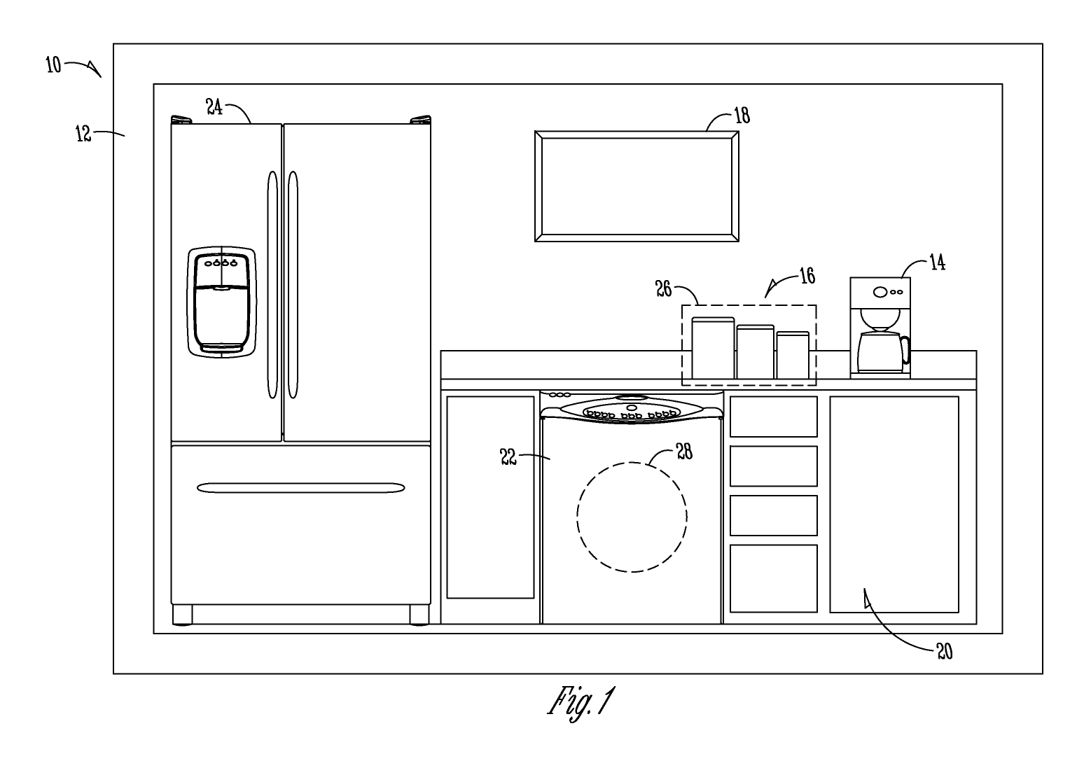

FIG. 1 illustrates a frame 10 of a video to be used as a working example in the present disclosure. In the exemplary frame 10 of the video illustrated FIG. 1, a kitchen is being televised on a flat-panel television 12. Such a frame 10 could arise in any number of videos, including sitcoms, cooking shows, movies, etc. The frame 10 of the kitchen can include any number of objects, products, advertisements, product placements, and the like. In the exemplary frame 10 illustrated in FIG. 1, the kitchen includes a coffeemaker 14, containers 16, a picture 18, cabinetry 20, a dishwasher 22, and a portion of a refrigerator 24.

For any number of reasons, a viewer of the television show having the frame 10 might wish to learn more about and/or purchase one or more of the objects contained on screen. Using, at least in part, the exemplary frame 10 of the kitchen, the process by which this is accomplished will be discussed consistent with the objects of the present disclosure.

The embodiment using post-production capture occurs after the video is in its final broadcast form. The video can be scanned. During the scanning process, the appearance and/or disappearance of products, goods, services, advertisements, music, sounds, and the like (hereinafter “objects”) can be noted. Either during the scanning process, or upon a subsequent playing of the video, the location and time of the objects of interest are recorded and characterized.

The present disclosure contemplates that this can be accomplished through any one or more means. In an exemplary embodiment, the object can be represented as an electronic tag 28 during the characterization process. The electronic tag 28 can be manually defined by an individual (e.g., video engineer) during the characterization process and/or applied by object recognition software. The electronic tags can be invisible of any size so as to permit a viewer to conveniently select the electronic tag 28 of the object with a pointing device, which will be discussed in detail below. The location of the objects of interest can be represented as an offset of the electronic tag 28 associated with the object from a predetermined point (e.g., the upper left corner) of the display. The offset can be expressed as x, y, z coordinates on the screen. The coordinates can be in the number of pixels; however, the present disclosure envisions the coordinates can be expressed as a distance, a ratio of vertical and/or horizontal distances from an edge of the screen, and the like.

In another exemplary embodiment, the location of the objects of interest can be represented by tracing the objects. More particularly, an invisible tracing of an outline of an object is generated and recorded. Whereas the electronic tags 28 are configured to roughly approximate the location of the object, the tracings are more precisely contoured to the objects on screen. The tracing can be manually defined during the characterization process and/or applied by object recognition software. As with electronic tags 28, the tracings 26 can be represented as an offset of the tracings 26 associated with the object from a predetermined point of the display. The offset can be expressed as x, y, and/or z coordinates on the screen.

The precision with which the outline of the object is traced can vary based on any number of factors. One factor can be the complexity of the outline of the object. In instances of complex outlines, it can be sufficient to trace the outline of the objects with lesser precision. Using the working example of the present disclosure, it may be sufficient to generate a rectangular tracing 26 for the containers 22 of the kitchen frame 10, as opposed to individually tracing each of the containers 22. Another factor can be the proximity of multiple objects of interest on the screen. In instances where there are closely-spaced objects and each is an object of interest, the tracing of each of the objects can be closely spaced so as to permit a viewer to select each object of interest. In other words, the tracing of each of the objects of interest should be such that no selectable area is associated with two objects (i.e., overlapping outlines of the objects of interest). Such a situation is more likely when objects of interest are staggered behind one another (i.e., along the z-axis) such that the object in front is at least partially obstructing the object behind.

Still another factor can be the static or dynamic nature of the object. For objects that are static on screen, the tracing of the object can be more widely spaced. This can provide a larger selectable area to stationary objects of interest. For objects of interest that are dynamic on screen, closer tracing may be desired. This requires a smaller selectable area for moveable objects of interest to ensure accuracy when a viewer selects the same.

Still yet another factor can be the perceived market popularity of an object. For objects that are perceived as more desirable, the tracing of the object can be more widely spaced. Conversely, for objects that are perceived as less desirable or no longer on the market, the tracing of the object can be more narrowly spaced or removed completely.

The location of the objects of interest are recorded and characterized as a function of time. As disclosed herein, the location of the electronic tags 28 and/or tracings 26 can be represented as x, y, and/or z coordinates. As commonly known in the art, the x-coordinate is associated with a left-right direction; the y-coordinate is associated with an up-down direction; and the z-coordinate is associated with a fore-aft direction. Time is preferably represented, for example, as an elapsed time in seconds from the beginning of the video. However, time can also be represented as an elapsed time from any point in the program (e.g., return from commercial, a tagged event in the program, etc.). Taken together, the characterization process, or the locations of an object of interest at a plurality of elapsed times, defines the trajectory of the object.

The plurality of elapsed times can be associated with each frame or groupings of frames (e.g., five frames, ten frames, etc.) of the video. Thus, for each frame or groups of frames, the location of the object of interest must be characterized. Given that typical television shows and movies are recorded at 40-50 frames per second and 70-80 frames per second, respectively, characterizing the trajectory of the objects of interest can be simplified through the use of object recognition software. The object recognition software is configured to recall objects that have been previously characterized. For example, if an object is characterized at two points five seconds apart (or perhaps two hundred frames apart), the object recognition software can be configured to fill in the gap between the two. The accuracy of the object recognition software can improve with each iteration of the characterization process such that the location of the object of interest can be manually defined fewer times subsequently. Further, the size and/or shape of an object's trajectory may need to be refined over time in order to be able to later resolve to which product the user is pointing and/or selecting. Still further, the number of object trajectories for a given video, or other media source, can change over time, and can vary depending upon the individual showing of the video (e.g., depending on the native language(s) of the display system, commercial versus educational use, regional markets, etc.). If two objects of interest are too similar, each may need to be independently characterized in order to maintain accuracy. A collating process can be used to determine the subset of object tracks available for the given video which are to be used for a given show package.

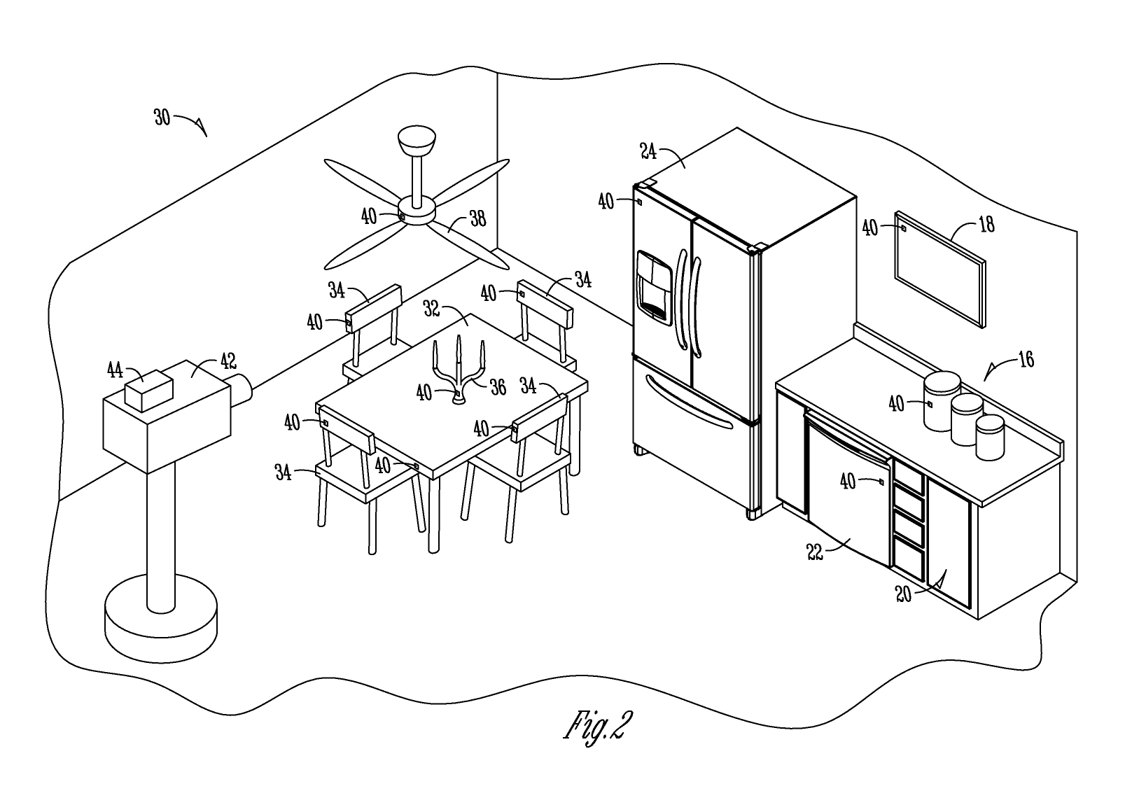

Using the working example of the present disclosure, the tracing 26 of the kitchen containers 22 might be positioned as illustrated in FIG. 2 at a time of 1:42 of the video. If the video begins to pan to the right, the containers 22 will move to the left on the television screen 12. Thus, at a time of 1:46, for example, the x-coordinate associated with the tracing 26 can be a lower numerical value than the frame associated with the time of 1:42. This shift will either needs to be defined through iterative tracing/tagging, or the object recognition software can iteratively define the trajectory of the containers 22.

The object trajectories can be compiled and stored for a particular video. One exemplary manner of doing so is through a tabular format or other numerical method. For instance, the location is reported versus time, as illustrated in the exemplary table below:

TABLE 1
Trajectories of the Coffeemaker (14) and Containers (16)

| Video | | | | | | |
|---|---|---|---|---|---|---|
| ID | Object | X | Y | Z | Time | SKU |
| TAR104 | Coffeemaker | 5.121 | 4.343 | 2.140 | 1:42 | 1462113Z |
| TAR104 | Coffeemaker | 4.927 | 4.343 | 2.140 | 1.46 | 1462113Z |
| TAR104 | Container | 4.129 | 4.341 | 2.140 | 1:42 | QQR16489 |
| TAR104 | Container | 3.945 | 4.341 | 2.140 | 1:46 | QQR16489 |
| TAR104 | Container | 3.719 | 4.341 | 2.140 | 1:48 | QQR16489 |

The trajectories of the objects of interest are compiled as metadata. The collection of metadata for an entire video can define a show package. The show package is stored with a system environment, as disclosed herein, and merged during the playing of a video. The show package can be abstracted to provide for a smooth playback with a compact data format, which can involve traditional numerical methods.

The trajectories of the objects of interest are correlated with items associated with products. Not limited to tangible goods, the items can include services or any other type of purchasable item that may be viewed in a video. Table 1 shows stock keeping units (SKUs) for objects of interest from the working example of the present disclosure. While SKUs are listed in Table 1, the present disclosure contemplates any other manner or method of identify items as commonly known in the art (e.g., universal product codes (UPC), internal product tracking, etc.) An exemplary method of interacting with the object trajectory includes a user viewing a video. The viewer is allowed to select an object trajectory (i.e., an x, y, z coordinate at a particular elapsed time) with a pointing device. Once the user determines, through on-screen feedback cues, that the pointing device is pointed correctly they can click a real or virtual button to indicate interest. The pointing device then transmits the time and location of the ‘click’ to the system. In a preferred embodiment, the pointing device uses intuitive camera based direct pointing and gesture control technology operably connected to a “smart” television. One such pointing device is the Philips® uWand™ direct pointing control. In another exemplary embodiment, the pointing device has motion sensor capability, either through optical sensors, infrared light emitting diode (LED) sensors, and the like. The pointing device operably can wirelessly connected to a sensor in electronic connection with the display. Thus, the pointing device provides consistent usage regardless of a television's type or size. Additional exemplary pointing devices can include mouse-based pointers, finger-based selection, and other means commonly known in the art.

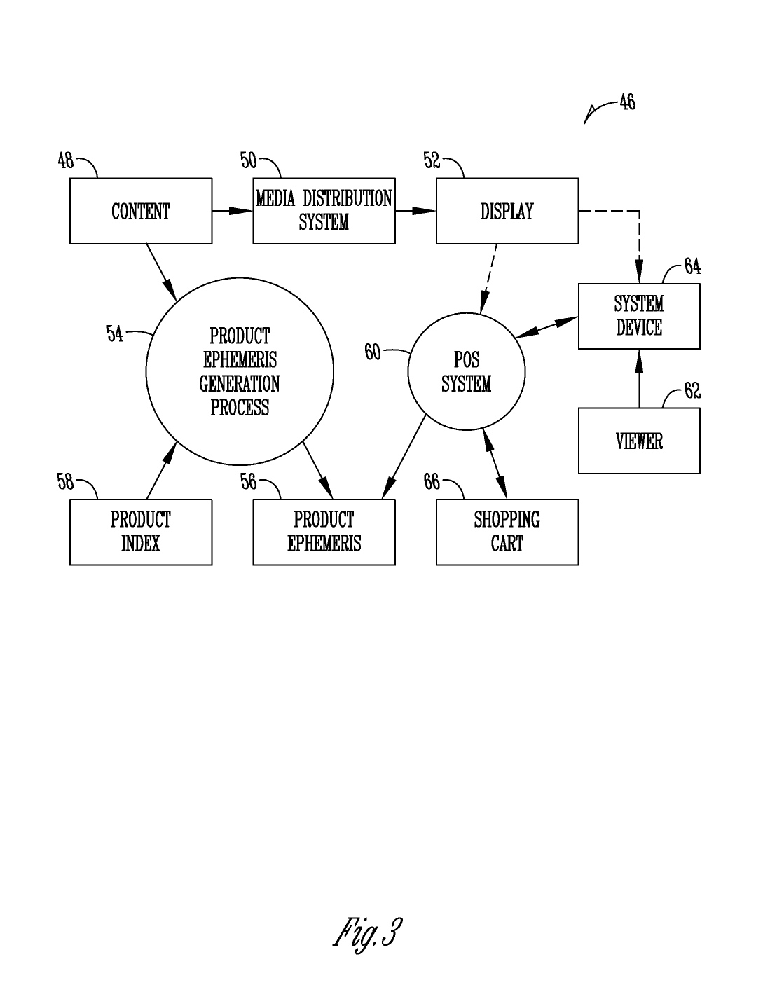

After the viewer selects an object trajectory, a point of sale (POS) system 60 (FIG. 3) identifies the items correlated to the selected trajectory. In particular, the POS system 60 accesses the metadata and identifies the items associated with the x, y, z coordinates at the elapsed time the viewer made the selection. In a preferred embodiment, the video continues to play during and after the selection is made. However, the present disclosure contemplates the video can be configured to pause once a viewer selects an object trajectory. In another exemplary embodiment, the step of allowing the viewer to select an object trajectory further includes isolating a segment of the video corresponding to the object trajectory prior to and after the selected object trajectory. More specifically, in instances where the video continues to play, a predetermined time (e.g., ten seconds) before and after the selected object trajectory is isolated and added into a digital area for later review by the viewer. This is advantageous for a viewer who did not react in time to click the object while on screen.

Once the items, and more specifically the products, correlated to the selected trajectory are identified, the product can be added to the digital area for later review and/or added to an electronic shopping cart for review and/or purchase. In a preferred embodiment, the product can be added to the digital area and/or electronic shopping cart without an alert to the viewer so as to not disturb the video. In an alternate embodiment, a thumbnail of the product can be seen in a corner of the viewing display. In certain embodiments, the pricing information associated with the product is not shown until the viewer reviews the product in the digital area and/or electronic shopping cart. The viewer is allowed to purchase the product from the electronic shopping cart.

While the disclosure discussed herein has been addressed to prerecorded videos such as prerecorded television broadcasts, the objects of the present disclosure can also be applied to live video capture. Referring to FIG. 2, a set 30 of a television show is illustrated. The set 30 includes, among other things, the containers 16, the picture 18, the cabinetry 20, the dishwasher 22, and the refrigerator 24, similar to the frame 10 of the post-production capture. The set can further include a table 32, chairs 34, centerpiece 36, and ceiling fan 38. In an exemplary embodiment of live capture, a sensor device 40 is physically applied to the objects of interest (16-38) that can be purchased. The sensor device 40 can include a digitally encoded “sticker” or tag. Examples of sensor devices 40 may include, but are not limited to optical bar codes, radiofrequency identification (RFID), wireless communication devices, etc. The sensor devices 40 are configured to operably relay signal to technology 44 associated with the camera 42. In the illustrated embodiment of FIG. 2, the technology 44 can include hardware electronically connected to the camera 42. To read the sensor devices 40, production sets may need to update or modify existing recording equipment to be able to locate these tags in the recorded frame as a function of time. Similarly, the production sets may require updates to the existing production and transmission processes to inject object trajectory data into the existing video data format. In a preferred embodiment, the signals from the sensor devices 40 are embedded on the film captured by the camera 42 or other record equipment.

When viewing the video generated through live capture, the POS system 60 identifies the objects of interest via the embedded data generated during the production. The objects of interest are correlated to an item (e.g., a product) as disclosed herein. A viewer is allowed to select an object of interest, after with the POS system 60 identifies the item. The item can be added to a digital area and/or an electronic shopping art. The viewer can purchase the item and/or learn additional information about the item.

Other exemplary uses of the system may include: continuous on-screen display of object and/or sound/music location and/or shape; creation of displays around the perimeter of the video indicating the objects on screen; and/or creation of spontaneous displays, either static or moving, on top of the video to highlight catalogued objects.

FIG. 3 illustrates an exemplary system 46 with which the objects of the present disclosure can be implemented. In a preferred embodiment, video content 48 is transmitted through a media distribution system 50 to a display 52, as commonly known in the art. The present disclosure contemplates that a media distribution system 50 is not necessary, as the objects of the present disclosure can be incorporated into any live or post-production capture video. In preferred embodiments, the video content 48 will be a television program or movie; however, this need not be the case. With the increasing popularity of internet streaming of clips, casting, and the like, the system 46 can be implemented on the same. Similarly, while the display 52 is preferably a television, the present disclosure contemplates the system 46 can be used on projects, tablets, smartphones, personal digital assistants (PDAs), projectors, computer screens, and the like.

Prior to the video distribution, the video content 48 undergoes a product ephemeris generation process 54. As disclosed herein, the product ephemeris generation process 54 includes determining locations and elapsed times within the video of objects of interest, and characterizing the trajectories of the objects of interest as locations as a function of elapsed times. In other words, the product ephemeris generation process 54 creates a time-ordered set of x, y, z coordinates, called a product ephemeris 56, describing the path or paths of the objects of interest.

The objects of interest can be determined prior to the product ephemeris generation process 54. In particular, a product index 58 can be generated of currently active objects of interest, most commonly products. The products are uniquely identified by a product identifier such as SKU, for example. Using the product index 58, the product ephemeris generation process 54 creates the product ephemeris 56. As disclosed herein, the product ephemeris is a catalog of object trajectories, or their paths across a video display as a function of time. The product ephemeris 56 can be database with the following information: Video Content ID—a unique identifier that identifies a unit of video content (e.g., an episode of a television series); Product ID—a unique identifier that identifies a product being offered; Time Tag—a time interval measured relative to the Video Content ID (e.g., the time from the beginning of the video content; and X, Y, and/or Z coordinates—numbers that identify a location on the display.

The product ephemeris 56 can be generated in any number of manual or automated ways, including but not limited to the following:
1. The video content is displayed as regular intervals, for example, one second.
2. For each frame, the x, y and/or z location of all objects of interest is determined and/or notated, along with the elapsed time in seconds from a certain point in the video.
3. Each of the observations in item two is entered as a separate row in the Product Ephemeris database (i.e., Video Content ID, Product ID, Time Tag, X, Y, and/or Z coordinates).
4. Steps 1 through 3 can be repeated for each new unit of video content that is added to the system.
5. If a new product is added to the product index 58, steps 1 through 3 can be repeated.
6. When products or video content are to be removed from the system 46, the associated data can be removed from the product index 58 and/or the product ephemeris 56.

The viewer inputs correspond to several of the columns of the product ephemeris database, such as Video Content ID, Time Tag, X, Y, and/or Z coordinates. The Content ID field is used to recover object trajectories related to the program being displayed. The Time Tag field is then used to eliminate products contained in the content that are not being displayed at the time in question. The location of each of the remaining products at the time in question can be obtained from the product ephemeris 56 with simple (e.g. linear) interpolation techniques. The interpolated product locations (i.e. their X, Y and Z coordinates) can then be compared with the X, Y and Z coordinates in question to determine if any or all of them are to be considered the candidate product.

The product ephemeris 56 is transmitted to a POS system 60. The POS system can be associated with the system 46 provider to all viewers. In such an embodiment, a centralized POS system 60 services all viewers. The POS system 60 reads, writes, and/or otherwise maintains the product ephemeris 56. In an exemplary embodiment disclosed herein, the product ephemeris 56 is comprised of metadata similar to that of Table 1 for show packages.

A viewer 62 uses a system device 64 operably connected to the display 52. In a preferred embodiment, the system device 64 includes the pointing device as disclosed herein. The system device 64 can further include hardware electronically connected to the display 52 that is in data communication with the POS system 60. In tangible form, the hardware can include a box-like structure containing electronic components. The box is designed to transmit and/or receive data from the POS system 60 for each of the viewers 62 using the system 46. In an embodiment, the box can also contain components configured to operably interact with the pointing device.

When a viewer 62 selects a video to view, the system device 64 transmits information to the POS system 60 indicating, among other things, which video the viewer 62 has selected to view. The POS system 60 can correlate the video with the appropriate the product ephemeris 56 having the show package and its metadata. In a preferred embodiment, the POS system 60 is configured to receive input from the system device 64, particularly upon a selection made by the viewer 62; i.e., selecting an object trajectory. The input can include a video content identification, a time tag, and coordinates sufficient to locate an object on the display. Using the product ephemeris 56, the POS system 60 can identify a candidate product associated with the object trajectory. The candidate product(s) can be deposited into a digital area for review or additional information and/or the electronic shopping cart 66. The system disclosed herein enables a POS system that accepts viewer inputs, interrogating the product ephemeris database, returns any or all objects relevant to the inputs, identifies products related to the objects, and allows the viewer to purchase the same.

The disclosure is not to be limited to the particular embodiments described herein. In particular, the disclosure contemplates numerous variations in which a viewer can interact and/or purchase objects within a video. The system described above is not restricted to a particular display medium, although one usage is a hand held device and any necessary sensing and display hardware that will allow the user to point the device at a television screen or monitor displaying the video and select the region of the screen containing an object. The system described above enables a user to buy anything viewed on a display with a pointing device. In addition to use in television shows, movies, and the like, this technology can apply to objects viewed in commercials so that customers can click during a commercial to immediately buy the product(s) being advertised. The technology can be enabled using a computer, set-top-box, smart televisions, media players, mobile device, etc.

The foregoing description has been presented for purposes of illustration and description. It is not intended to be an exhaustive list or limit any of the disclosure to the precise forms disclosed. It is contemplated that other alternatives or exemplary aspects that are considered included in the disclosure. The description is merely examples of embodiments, processes or methods of the disclosure. It is understood that any other modifications, substitutions, and/or additions can be made, which are within the intended spirit and scope of the disclosure. For the foregoing, it can be seen that the disclosure accomplishes at least all that is intended.

The previous detailed description is of a small number of embodiments for implementing the disclosure and is not intended to be limiting in scope. The following claims set forth a number of the embodiments of the disclosure with greater particularity.

1. A method for enabling a viewer to interact with objects within a video, the method comprising the steps of:
determining elapsed times of the video of the objects;
determining locations within the video of the objects;
characterizing trajectories of the objects with the locations as a function of the elapsed times through a product ephemeris generation process;
correlating the trajectories of the objects with one or more products from a product index;
allowing the viewer to select one of the trajectories with a pointing device; and
identifying candidate products correlated to the selected trajectory.

2. The method of claim 1 wherein the step of characterizing the trajectories of the objects further comprises recording on-screen x, y, and/or z coordinates of the objects at a plurality of the elapsed times.

3. The method of claim 1 wherein the step of recording the location within the video further includes the step of tracing the objects.

4. The method as of claim 1 further comprising the step of:
adding the correlated products to an electronic shopping cart.

5. The method of claim 1, wherein the step of allowing the viewer to select the trajectories with the pointing device further comprises:
isolating a segment of the video both before and after the viewer selection;
depositing the isolated segment of the video into a digital area for later review by the viewer.

6. The method of claim 4 wherein the video is pre-recorded videos.

7. The method of claim 3 wherein the tracing of the objects is not visible on-screen.

8. The method of claim 7 wherein the tracing of the objects is closely contoured to an outline of the obj ects when the objects are dynamic.

9. The method of claim 7 wherein the tracing of the objects is loosely contoured to an outline of the objects when the objects are static.

10. The method of claim 1 wherein the characterizing the trajectories of the objects further comprises using object recognition software.

11. A method for allowing a viewer to interact with an object within a prerecorded video, the method comprising the steps of:
providing a pointing device and an electronic shopping cart;
characterizing the object within the prerecorded video as a trajectory, wherein the trajectory of the object represents the location as a function of elapsed time of the video; and
correlating the trajectory of the object with a product; and
allowing the viewer to select a location within the prerecorded video with the pointing device, wherein the location is associated with the object.

12. The method of claim 11 further comprising the step of associating the product with the electronic shopping cart.

13. The method of claim 12 further comprising the step of allowing the viewer to purchase the product.

14. The method as in any of claim 11 wherein the step of characterizing the object within the prerecorded video further includes:
iteratively tracing the object; and
representing the tracing of the object as x, y, and/or z coordinates as the function of the elapsed time of the video.

15. The method of claim 14 wherein the tracing is not visible to the viewer during viewing of the video.

16. The method of claim 14 wherein the video is a prerecorded television broadcast.

17. A system of identifying or purchasing an object in video content, the system comprising:
a display through which video content is displayed;
a product ephemeris generation process configured to create a product ephemeris comprised of a time-ordered set of x, y, and/or z coordinates that describe the path or paths of the object contained in a product index;
a point of sale system configured to receive input from a system device upon activation by a user, wherein the input comprises:
(a) a video content identification;
(b) a time tag;
(c) coordinates sufficient to locate the object on the display; and
wherein the point of sale system correlates the received input with one or more candidate products from the product ephemeris.

18. The system of claim 17 further comprising an electronic shopping cart, wherein the point of sale system deposits the one or more candidate products into the electronic shopping cart.

19. The system of claim 17 wherein the user purchases the one or more candidate products with the point of sale system.

20. The system of claim 19 wherein the video content is transmitted by a media distribution system.

21. A method for enabling selection of an object of interest viewed on a video, the method comprising the steps of:
associating the object of interest with an identifier of the video;
tracing the object of interest to create a selectable area within the video;
defining the selectable area within the video as a time-ordered set of x, y, and/or z coordinates;
receiving input from a system device upon activation by a user, wherein the activation comprises selecting selected time-ordered set of x, y, and/or z coordinates with a pointing device;
correlating the selected time-ordered set of x, y, and/or z coordinates with the selectable area; and
correlating the selectable area with a product associated with a product index and the identifier of the video.

22. The method of claim 21 further comprising the step of allowing the user to purchase the product.

23. The method of claim 21 wherein the selectable area is defined as multiple time-ordered sets of x, y, and/or z coordinates, wherein the multiple time-ordered sets of x, y, and/or z coordinates comprise points of a trajectory of the obj ect of interest.

24. The method of claim 23 wherein the trajectory of the object of interest between the points is determined by object recognition software.
